(19) United States
(12) Patent Application Publication
(10) Pub. No.: US 2014/0008441 A1
(43) Pub. Date: Jan. 9, 2014

(54) Authenticating Label

(71) Applicant: Dieu Dai Huynh, Courcouronnes (FR)

(72) Inventor: Dieu Dai Huynh, Courcouronnes (FR)

(73) Assignee: Avery Dennison Corporation, Pasadena, CA (US)

(21) Appl. No.: 13/985,503

(22) PCT Filed: Mar. 26, 2012
(86) PCT No.: PCT/US12/30504

§ 371 Date: Aug. 14, 2013

Related U.S. Application Data
(60) Provisional application No. 61/467,540, filed on Mar. 25, 2011.

(51) Int. Cl. G09F 3/10

(52) U.S. Cl. CPC G09F 3/10
USPC 235/468; 40/638; 427/157

(57) ABSTRACT

A label having a region or layer of luminescent ink is described. The label includes a generally transparent facestock layer and a layer of an adhesive. The luminescent ink is disposed between the facestock layer and the adhesive layer. Upon exposure to ultraviolet light, the luminescent ink emits visible light. The label can be used to provide an indication as to the authenticity or genuineness of a product to which the label is attached. Also described are various methods of using the label.

### CROSS REFERENCES TO RELATED APPLICATIONS

This application claims priority upon U.S. provisional application Ser. No. 61/467,540, filed Mar. 25, 2011, which is incorporated herein by reference in its entirety.

### FIELD

The present subject matter relates to labels having a layer or region of a luminescent ink. The labels can be used to provide authentication or verification as to the origin and/or genuineness of an article to which the label is attached.

### BACKGROUND

The use of counterfeit or non-genuine products is a serious problem in many situations. For example, the use of counterfeit automobile or aircraft parts not only constitutes a fraud on the purchaser but also may lead to serious safety problems. Even more significantly, the use of non-authentic or generic pharmaceutical products when the authentic pharmaceutical product is thought to be used can cause serious health consequences for the patient and can lead to malpractice claims against physicians and hospitals.

Therefore, a security label is needed that can indicate the authenticity of a product to which the label is attached.

### SUMMARY

The difficulties and drawbacks associated with previously known products and practices are addressed in the present subject matter labels and associated methods.

In one aspect, the present subject matter provides a label comprising a transparent facestock layer, and adhesive layer, and a layer of a luminescent ink disposed between the facestock layer and the adhesive layer. The luminescent ink emits visible light upon exposure to ultraviolet light.

In another aspect, the present subject matter provides a method of producing a luminescent label. The method comprises providing a transparent facestock layer, applying a layer of a luminescent ink on the facestock stock, and applying an adhesive layer on the layer of the luminescent ink to thereby form a luminescent label.

In still another aspect, the present subject matter provides a method of verifying origin of an article. The method comprises providing at least one article of known origin. The method also comprises securely attaching a luminescent label to the article of known origin. The label includes a transparent facestock layer, an adhesive layer, and a layer of a luminescent ink disposed between the facestock layer and the adhesive layer. The luminescent ink emits visible light upon exposure to ultraviolet light. The method also comprises obtaining a labeled article of unverified origin. The article of unverified origin has a label attached thereto. And, the method also comprises irradiating the label attached to the article of unverified origin with ultraviolet light. If visible light is emitted, verification is provided that the article of unverified origin is an article of known origin.

As will be realized, the subject matter is capable of other and different embodiments and its several details are capable of modifications in various respects, all without departing from the subject matter. Accordingly, the drawing and description are to be regarded as illustrative and not restrictive.

### BRIEF DESCRIPTION OF THE DRAWINGS

FIG. 1 is a schematic cross sectional view of a preferred embodiment label in accordance with the subject matter.

### DETAILED DESCRIPTION

Before turning attention to the present subject matter, it is instructive to address several terms typically used in describing light emission. Luminescence is a light emission in which the emission is not caused by heating and lasts for a time period exceeding the period of electromagnetic oscillation. This indicates two things. First, luminescence is distinguishable from light emission caused by thermal radiation, for example the light emitted from warm or hot incandescent bodies. Visible light from thermal radiation begins emitting at minimum temperatures of several hundred degrees Kelvin while luminescence can be observed at any temperature. Thus, luminescence is sometimes referred to as “cold light.” Second, luminescence occurs for a time period exceeding the period of electromagnetic oscillation, thereby distinguishing luminescence from reflected and stray light. In luminescence, intermediate processes occur between absorption and emission duration which exceed the time period of a single electromagnetic oscillation. As a result, luminescence loses correlation between phases of absorbed and emitted light, in contrast to reflected and stray light, in which the phase correlation can always be observed.

Photoluminescence is luminescence stimulated by light absorption in the ultraviolet (UV), visible, and/or near infrared (NIR) spectral region, and represents any process in which material absorbs electromagnetic energy at a certain wavelength and then emits a portion of the electromagnetic energy at a different (usually longer) wavelength. Therefore, in photoluminescence, only a portion of the absorbed energy is transformed into luminescent light. The remaining portion of the energy ends up as molecular vibrations, or simply as heat. Photoluminescence is the most frequently observed type of luminescence because a large selection of reliable and inexpensive excitation sources are available and also because the effect can often be observed with the naked eye. Usually an excitation source emits light in the UV region and the photoluminescence occurs in the visible or NIR spectral region.

Photoluminescence is further classified according to the time period associated with the emission. There is always a time delay between the moment a material has absorbed a higher energy photon and the moment a secondary lower energy photon is re-emitted. This delay is defined by the lifetime of excitation states, or simply by how long atoms or molecules are able to stay in excited high-energy conditions. Delay time can vary by many orders of magnitude for different materials. Based on practical observations, two types of photoluminescence were historically established—fluorescence and phosphorescence. Technically, delay time is the only difference between these types of photoluminescence. The delay time is shorter for fluorescence (10⁻¹² seconds to 10⁻⁷ seconds) and much longer for phosphorescence (up to a few hours and even days).

Therefore, fluorescence is a “fast” photoluminescence. The effect is widely used in such everyday practical applications as industrial and residential lightning (neon and fluorescent lamps), as an analytical technique in science, and as a quality and process control method in industry.

Phosphorescence is a “slow” photoluminescence. In contrast to fluorescence, phosphorescence demonstrates itself as a glowing that lasts long after the excitation light is gone. Phosphorescent materials are sometimes referred to as “glow-in-the-dark”. This effect is typically used by road signs to attract drivers' attention, in advertising campaigns to produce glowing stickers and promotional materials, as well as in numerous industries to notify people of potential hazards and dangers.

The present subject matter relates to a label assembly that includes a layer of a luminescent ink which is invisible (under ambient or visible light), but which is visible under ultraviolet light. Specifically, the label assembly includes (i) a transparent facestock layer, (ii) a layer or region of the luminescent ink, and (iii) a layer of an adhesive. It is significant that the layer of luminescent ink is “sandwiched” or disposed between the facestock and adhesive layers, e.g. layers (i) and (iii). Throughout this disclosure, the term “layer” refers to either a continuous material layer, a discontinuous layer, or a discrete material layer.

### Facestock Layer

The preferred embodiment label assemblies include a facestock film or layer to provide support for the label. The facestock layer can be formed from a wide array of materials such as polyester film materials, polyolefin film materials or paper, cardboard, or other paper-based materials. Representative materials for the outer support include, but are not limited to, polyethylene terephthalate (PET), polyethylene (PE), polypropylene (PP), both oriented and nonoriented, and copolymers thereof. Another example of a potentially suitable film for the facestock is a layer of polyvinyl chloride (PVC) and copolymers thereof. Additional materials include, but are not limited to, ortho-phthalaldehyde (OPA). For many applications, PET is preferred. In addition, it may be preferred to utilize a biaxially oriented polypropylene (BOPP) material. These materials provide cost savings as they are relatively inexpensive, and they have sufficient stiffness to dispense well.

The facestock can be utilized at various thicknesses in the label assembly. The facestock can have a typical thickness of from about 10 to about 120 microns, and a preferred thickness of from about 25 to about 85 microns.

Preferably, the facestock layer is transparent or substantially so. This is because the facestock layer is disposed over and generally upon an underlying luminescent ink layer, described in greater detail herein. Therefore, the facestock layer should exhibit sufficient transparency such that light (typically in the ultraviolet spectrum) can pass through the facestock layer to the luminescent ink layer, induce luminescence of that layer, and allow the light emitted by the ink (typically in the visible spectrum) to pass through the facestock layer to a viewer. Preferably, the transmittance of the facestock layer is at least 80%, more preferably at least 90%, and most preferably at least 95%. The term “transmittance” as used herein refers to the percentage of light that passes through the facestock layer in a single pass in the UV or visible spectral region.

Since the outer face of the facestock will likely constitute the outermost surface of the label, in certain embodiments, the material selected for the facestock, at least along this outwardly directed face, preferably exhibits attractive printability characteristics.

Printability is typically defined by the sharpness and brightness of the image and by ink anchorage. The sharpness is closely related to the surface tension of the print surface. The ink anchorage is often tested by a tape test (Finat test: FTM21). In general, PVC is printable with a variety of inks intended to be used with PVC. In most occasions the inks are water-based (especially in the US) or designed for UV drying (especially in Europe). In general, all polyolefin films can be printed with UV inks after on-press corona treatment, PE being better than PP mainly on ink adhesion. For waterbased inks an additional primer or topcoat is preferred to achieve good ink anchorage.

As explained herein, the facestock layer may include an optional printing layer disposed on an outer face of the facestock or below the outer face of the facestock.

### Luminescent Ink Layer

The preferred embodiment label assemblies also comprise a region or layer of a luminescent ink or material. Preferably, the luminescent ink or material is a photoluminescent ink or material. Most preferably, the luminescent ink or material is a fluorescent ink or material. However, the preferred labels can also include a phosphorescent ink.

Preferably, the luminescent ink comprises a water based resin and one or more luminescent pigments, agents, or materials. Any suitable water based resin can be used such as for example, a polyurethane resin or an acrylic resin. The concentration of the luminescent pigment, agent, or material in the water based resin is typically from about 0.1% to about 10%, preferably from about 1% to about 5%, and most preferably about 3%. All percentages noted herein are by weight unless noted otherwise. The luminescent ink can include one or more additional components. Typically, the concentration of the one or more additional components is from about 0.1% to about 20%, preferably from about 1% to about 15%, and most preferably about 10%.

The thickness of the luminescent ink layer is typically from about 1 micron to about 10 microns, preferably from about 3 microns to about 7 microns, and most preferably about 5 microns.

The luminescent ink is preferably formulated such that upon exposure or irradiation by light in the ultraviolet spectrum, the ink emits light in the visible spectrum and most preferably light having a red color. Light in the ultraviolet spectrum has a wavelength of from about 10 nm to about 400 nm. Light in the visible spectrum has a wavelength of from about 400 nm to about 750 nm. Light having a red color has a wavelength of from about 620 nm to about 750 nm.

It is also contemplated that the luminescent ink can be applied or otherwise incorporated in the label in a pattern fashion. For example, instead of forming a continuous or substantially continuous layer of the luminescent ink, a pattern configuration could be utilized having continuous regions separated by one or more ink-free regions. Moreover, as explained in greater detail herein, the luminescent ink can also be used to provide one or more numbers, letters, symbols, informational elements, or combinations thereof. These identifying or information providing indicia or elements can be incorporated in the label and preferably between the facestock and the adhesive layer.

A wide array of luminescent inks are known in the art, for example as described in U.S. 2007/0225402; U.S. Pat. No. 6,554,480; and U.S. Pat. No. 4,865,937. Examples of suitable fluorescent inks are described in U.S. 2010/0143578; U.S. Pat. No. 5,256,192; and U.S. Pat. No. 7,473,437. Additional details and information concerning suitable inks for use in the labels described herein are provided in U.S. 2002/0195586; U.S. 2003/000530; and U.S. 2003/0041774. Luminescent pigments, agents, and/or materials are commercially available from various suppliers such as for example Clariant International or Ciba Specialty Chemicals (now BASF).

### Adhesive Layer

The preferred embodiment label assemblies include an adhesive layer. In one embodiment, the adhesive layer is a pressure sensitive adhesive layer and the adhesive provides a tacky surface allowing a bond to another contacting surface. Preferably, the properties of the adhesive are such that the bond also provides a seal to prevent or at least significantly prevent the flow of air or other agents across the region of the adhesive. The adhesive layer may be a single adhesive layer or may be a multilayer adhesive.

A wide range of adhesives can be used in this layer so long as their properties and characteristics are consistent with the packaging and/or application requirements of the resulting label assembly. Specifically, the selected adhesive must be chemically compatible with the ink layer. The adhesive could be a hot melt pressure sensitive adhesive, such as for example a rubber-based or acrylic-based pressure sensitive adhesive. The adhesive could be a UV cured hot melt. The adhesive could be based on a rubber-based hot melt composition, a solvent rubber adhesive, a solvent acrylic adhesive, or a solvent polyurethane adhesive. The adhesive could be emulsion-based such as an emulsion acrylic adhesive. As noted, a wide array of adhesives could be used. Each of the aforementioned adhesives are preferably in the form of a pressure sensitive adhesive (PSA). An extensive selection of various pressure sensitive adhesives are disclosed in U.S. Pat. Nos. 5,623,011; 5,830,571; and 6,147,165; owned by the assignee of the present application.

A preferred pressure sensitive adhesive for use in the pressure sensitive adhesive layer is commercially available under the designation Fasson® S692N. The S692N adhesive is an acrylic emulsion based adhesive. Generally, this adhesive is a polymeric blend of butyl acrylate and 2-ethyl-hexyl acrylate monomers with various tackifiers and processing acids. Other preferred pressure sensitive adhesives include, but are not limited to, emulsion acrylic adhesives and rubber-based hot melt adhesives.

The thickness of the pressure sensitive adhesive layer typically ranges from about 5 to about 40 microns and preferably from about 15 to about 22 microns. It will be understood however, that the present subject matter includes cover laminates using thicknesses greater than or lesser than these thicknesses for the pressure sensitive adhesive layer.

### Optional Release Layer

In accordance with another embodiment of the subject matter, the label assembly includes an optional release or liner layer. Preferably, the release layer is disposed immediately adjacent to the pressure sensitive adhesive layer in the label. The release layer provides a release surface which is immediately adjacent to, and in contact with, the pressure sensitive adhesive layer.

A wide variety of release materials such as those typically used for pressure sensitive tapes and labels are known, including silicones, alkyds, stearyl derivatives of vinyl polymers (such as polyvinyl stearyl carbamate), stearate chromic chloride, stearamides and the like. Fluorocarbon polymer coated release liners are also known but are relatively expensive. For most pressure sensitive adhesive applications, silicones are by far the most frequently used materials. Silicone release coatings have easy release at both high and low peel rates, making them suitable for a variety of production methods and applications.

Known silicone release coating systems generally include a reactive silicone polymer, e.g., an organopolysiloxane (often referred to as a “polysiloxane,” or simply, “siloxane”); a cross-linker; and a catalyst. After being applied to the adjacent layer or other substrate, the coating generally must be cured to cross-link the silicone polymer chains, either thermally or radiatively (by, e.g., ultraviolet or electron beam irradiation).

Based on the manner in which they are applied, three basic types of silicone release coatings used in the pressure sensitive adhesive industry are known: solvent borne, water borne emulsions, and solvent free coatings. Each type has advantages and disadvantages. Solvent borne silicone release coatings have been used extensively but, because they employ a hydrocarbon solvent, their use in recent years has tapered off due to increasingly strict air pollution regulations, high energy requirements, and high cost. Indeed, the energy requirements of solvent recovery or incineration generally exceed that of the coating operation itself.

Water borne silicone emulsion release systems are as well known as solvent systems, and have been used on a variety of pressure sensitive products, including tapes, floor tiles, and vinyl wall coverings. Their use has been limited, however, by problems associated with applying them to paper substrates. Water swells paper fibers, destroying the dimensional stability of the release liner backing and causing sheet curling and subsequent processing difficulties.

Solventless or solvent free silicone release coatings have grown in recent years and now represent a major segment of the silicone release coating market. Like other silicone coatings, they must be cured after being applied to the flexible liner substrate. Curing produces a cross-linked film that resists penetration by the pressure sensitive adhesive.

Informative descriptions of various release materials, their characteristics, and incorporation in laminate assemblies are provided in U.S. Pat. Nos. 5,728,469; 6,486,267; and U.S. Published Patent Application 2005/0074549, owned by the assignee of the present application. It is also contemplated that various waxes known in the art could be used for the release material or utilized in the release layer.

The preferred labels utilize release layers that are relatively thin. For example, a typical release layer thickness is from about 1 to about 4 microns. Preferably, the thickness of the release layer is from about 1 to about 2 microns.

### Additional Optional Layers

It is also contemplated that the preferred embodiment label assemblies can also comprise one or more additional layers such as a secondary substrate, a topcoat, a sealing layer, a protective layer, and combinations thereof.

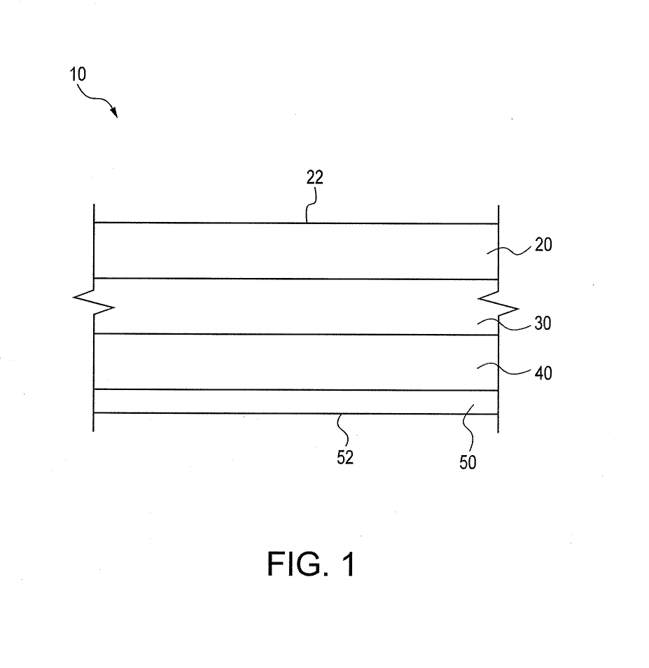

FIG. 1 is a schematic cross sectional view of a preferred embodiment label 10 in accordance with the present subject matter. The label 10 comprises a generally transparent facestock layer 20, a layer of a luminescent ink 30, and an adhesive layer 40. The ink layer 30 is disposed between the facestock layer 20 and the adhesive layer 40. The facestock layer 20 defines an outer surface 22 through which the ink layer 30 can be viewed. The label 10 may also comprise an optional release layer 50 adjacent to the adhesive layer 40. The label 10 also defines an underside 52 oppositely directed from the outer surface 22.

### Methods

The present subject matter also provides methods of forming or producing the noted label assemblies and methods of using the label assemblies.

A preferred method of forming the label assemblies described herein comprises providing a web or layer of the facestock material. A luminescent ink is obtained and then applied to a face or region of the facestock. Application of the ink is preferably by any known liquid application technique and preferably by spraying, roll coating, or printing the ink onto the facestock. The ink is then dried or at least partially dried. An effective amount of an adhesive is then applied to the ink and underlying facestock. Any known technique typically used for applying the adhesive can be utilized. One or more optional layers can be applied or otherwise incorporated into the laminate assembly.

It is also contemplated that instead of applying the luminescent ink to the facestock, the ink could be applied onto the adhesive layer. After sufficient drying of the ink, if necessary, a facestock layer could be applied onto the ink and underlying adhesive layer.

The subject matter also includes other variants in which all or a portion of the luminescent ink is applied onto the adhesive layer and an optional remaining portion of the ink applied to the facestock layer. The facestock layer with an optional portion of the ink is then mated with the adhesive layer also carrying a portion of the ink.

In still other embodiments, all or a portion of the luminescent ink, or the luminescent pigment, agent or material, can be incorporated in the adhesive layer. For example, all or a portion of the luminescent pigment, agent or material could be blended in the adhesive and then upon applying the adhesive and forming the adhesive layer, the luminescent pigment, agent or material is dispersed throughout the adhesive layer. This strategy can be used in conjunction with providing a layer of luminescent ink which can include the same or different luminescent pigment, agent or material.

The present subject matter also provides methods of using the various labels described herein. Typically, one or more labels are adhesively attached to an article or package for which verification is desired. After attachment of the label to the article or package of interest, verification as to source or type of article for example can be readily performed by exposing or irradiating the label to UV light. Upon such exposure, the label then emits visible light, thereby providing verification that the article or package (to which the label is attached) is genuine, originates from a particular source, or is as described, for example.

Another technique for providing verification or for providing additional verification that a product or article originates from a particular source or on a certain date or time involves forming one or more numbers, letters, symbols, informational elements from the luminescent ink. For example, information pertaining to the product, manufacturer, or product origin, can be incorporated in the label by printing that information using the luminescent ink. Printing can be performed upon the facestock layer and/or the adhesive layer of the label assembly. Then, upon irradiating the label (attached to the product or its packaging) with UV light, the printed information becomes visible.

Many other benefits will no doubt become apparent from future application and development of this technology.

All patents, published applications, and articles noted herein are hereby incorporated by reference in their entirety.

It will be understood that any one or more feature or component of one embodiment described herein can be combined with one or more other features or components of another embodiment. Thus, the present subject matter includes any and all combinations of components or features of the embodiments described herein.

As described hereinabove, the present subject matter solves many problems associated with previously known products and practices. However, it will be appreciated that various changes in the details, materials and arrangements of components, which have been herein described and illustrated in order to explain the nature of the subject matter, may be made by those skilled in the art without departing from the principle and scope of the subject matter, as expressed in the appended claims.

1. A label comprising:
a transparent facestock layer;
an adhesive layer; and
a layer of a luminescent ink disposed between the facestock layer and the adhesive layer, wherein the luminescent ink emits visible light upon exposure to ultraviolet light.

2. The label of claim 1 wherein the transparent facestock layer includes a material selected from the group consisting of polyethylene, polyethylene terephthalate, biaxially-oriented polypropylene, and combinations thereof.

3. The label of claim 1 wherein the transparent facestock layer has a thickness of from about 10 to about 120 microns.

4. The label of claim 3 wherein the transparent facestock layer has a thickness of from about 25 to about 85 microns.

5. The label of claim 1 wherein the transparent facestock layer exhibits a transmittance of at least 80%.

6. The label of claim 5 wherein the transparent facestock layer, exhibits a transmittance of at least 90%.

7. The label of claim 6 wherein the transparent facestock layer exhibits a transmittance of at least 95%.

8. The label of claim 1. wherein the luminescent ink is a photoluminescent ink.

9. The label of claim 8 wherein the photoluminescent ink is a fluorescent ink.

10. The label of claim 8 wherein the photoluminescent ink is a phosphorescent ink.

11. The label of claim 1 wherein the luminescent ink comprises a water based resin and at least one luminescent pigment, agent, or material.

12. The label of claim 11 wherein the water based resin is either a polyurethane resin or an acrylic resin.

13. The label of claim 11 wherein the concentration of the luminescent pigment, agent, or material in the water based resin is from about 0.1% to about 10% by weight.

14. The label of claim 13 wherein the concentration of the luminescent pigment, agent, or material in the water based resin is from about 1% to about 5% by weight.

15. The label of claim 14 wherein the concentration of the luminescent pigment, agent, or material in the water based resin is about 3%.

16. The label of claim 1 wherein the thickness of the luminescent ink layer is from about 1 micron to about 10 microns.

17. The label of claim 16 wherein the thickness of the luminescent ink layer is from about 3 microns to about 7 microns.

18. The label of claim 17 wherein the thickness of the luminescent ink layer is about 5 microns.

19. The label of claim 1 wherein the visible light has a wavelength of from about 400 nm to about 750 nm.

20. The label of claim 1 wherein the ultraviolet light has a wavelength of from about 10 nm to about 400 nm.

21. The label of claim 1 wherein the adhesive layer includes an adhesive selected from the group consisting of a solvent adhesive, a hot melt adhesive, an emulsion based adhesive, and combinations thereof.

22. The label of claim 1 wherein the adhesive layer includes a pressure sensitive adhesive.

23. The label of claim 1 wherein the adhesive layer includes an acrylic emulsion based pressure sensitive adhesive.

24. The label of claim 23 wherein the acrylic emulsion based pressure sensitive adhesive includes a polymeric blend of butyl acrylate and 2-ethyl-hexyl acrylate monomers.

25. The label of claim 1 wherein the adhesive layer has a thickness of from about 5 to about 40 microns.

26. The label of claim 25 wherein the adhesive layer has a thickness of from about 15 to about 22 microns.

27. The label of claim 1 further comprising at least one other layer.

28. The label of claim 27 wherein the other layer includes a release layer disposed immediately alongside the adhesive layer.

29. The label of claim 28 wherein the release layer has a thickness of from about 1 to about 4 microns.

30. The label of claim 29 wherein the release layer has a thickness of from about 1 to about 2 microns.

31. A method of preparing a luminescent label, the method comprising:
providing a transparent facestock layer;
applying a layer of a luminescent ink on the facestock stock; and
applying an adhesive layer on the layer of the luminescent ink to thereby form a luminescent label.

32. The method of claim 31 wherein applying the layer of a luminescent ink is performed by at least one of spraying, roll coating, and printing.

33. A method of verifying origin of an article, the method comprising:
providing at least one article of known origin;
securely attaching a luminescent label to the article of known origin, the label including a transparent facestock layer, an adhesive layer, and a layer of a luminescent ink disposed between the facestock layer and the adhesive layer, wherein the luminescent ink emits visible light upon exposure to ultraviolet light;
obtaining an article of unverified origin, the article of unverified origin having a label attached thereto; and
irradiating the label attached to the article of unverified origin with ultraviolet light, wherein if visible light is emitted, verification is provided that the article of unverified origin is an article of known origin.

34. The method of claim 33 wherein the layer of the luminescent ink of the label attached to the article of known origin is patterned.

35. The method of claim 34 wherein the patterned layer of the luminescent ink includes at least one number, letter, symbol, or information element.
